(19) United States
(12) Patent Application Publication
(10) Pub. No.: US 2012/0262286 A1
(43) Pub. Date: Oct. 18, 2012

(54) SMART TIRE-PRESSURE SENSING SYSTEM AND AUTOMATIC MATCHING METHOD THEREOF

(76) Inventors: Kuei-Chi HO, Taichung City (TW); Hsin-Chieh Chen, Taichung City (TW)

(21) Appl. No.: 13/087,006

(22) Filed: Apr. 14, 2011

(51) Int. Cl. B60C 23/02

(52) U.S. Cl. 340/442

(57) ABSTRACT

A smart tire-pressure sensing system and an automatic matching method thereof are disclosed. The smart tire-pressure sensing system has a tire-pressure sensor compatible to multiple encoding systems. The tire-pressure sensor is configured to select one of the encoding systems according to a code identification signal so as to have signal communication with a host. The automatic matching method includes: a) installing the tire-pressure sensor compatible to multiple encoding systems to a tire to be monitored; b) inflating the tire to make its tire pressure greater than a preset threshold; c) entering the tire-pressure sensor into an installing process; d) sending a code identification signal to the tire-pressure sensor; e) making the tire-pressure sensor receive the code identification signal and select one of the encoding systems according to the code identification signal; and f) establishing the signal communication between the tire-pressure sensor and the host.

### BACKGROUND OF THE INVENTION

1. Technical Field

The present invention relates to a smart tire-pressure sensing system, which features a method for automatically matching and communicating a tire-pressure sensor with hosts in multiple encoding systems.

2. Description of Related Art

Motor vehicles are undoubtedly the most important transportation to modern people, and therefore more and more attention has been paid to driving safety. For ensuring driving safety, tire pressure of vehicle tires is one major subject matter to be well controlled. Improper tire pressure can lead to greater fuel consumption and inferior vehicle controllability, which threatens the safety of the drivers and the passengers.

A conventional tire-pressure sensing system includes a tire-pressure sensor configured to be installed in a tire of a vehicle for detecting air pressure and temperature inside the tire and transmitting the detected data through a transmitting device inside the tire-pressure sensor to a host installed on the vehicle, so as to facilitate a driver in the vehicle to see the data through a display communicating with the host.

However, different manufactures of tire-pressure sensing systems typically use different encoding systems to communicate tire-pressure sensors and hosts. Consequently, cars of different brands and times have their tire-pressure sensors and hosts provided with respective encoding systems that are not reprogrammable or revisable, meaning that tire-pressure sensors and hosts using different encoding systems cannot have common communication. As a result, the use of tire-pressure sensors is limited.

In view of this, there have been many tire-pressure sensors each compatible to multiple encoding systems for working with hosts using different encoding systems. However, for switching among encoding systems, such existing tire-pressure sensors mostly adopt a manual switch mechanism or have a cable connected to a computer or microprocessor for transmitting instruction of the suitable encoding system, and require operators to operate the devices mutually or to use the computer or microprocessor to confirm the encoding system used in the host before the tire-pressure sensor is installed. Since the tire-pressure sensor is usually installed on the wheel rim inside the tire, the encoding system set incorrectly can be never reset unless the installed and inflated tire is discharged and removed from the rim, thus being inconvenient and troublesome.

### SUMMARY OF THE INVENTION

To solve the foregoing problems, the present invention provides a smart tire-pressure sensing system and its automatic matching method. The present invention allows automatic selection of a suitable encoding system for a tire-pressure sensor to issue a detection signal readable to a host, thereby allowing the host to obtain data of tire pressure detected by the tire-pressure sensor.

The automatic matching method for a smart tire-pressure sensing system of the present invention includes steps of:

a) installing the tire-pressure sensor compatible to multiple encoding systems into a tire to be monitored;

b) inflating the tire to make the tire pressure thereof greater than a preset threshold;

c) when the tire-pressure sensor detects that the tire pressure is greater than the preset threshold, entering the tire-pressure sensor into an installing process;

d) transmitting a code identification signal to the tire-pressure sensor;

e) making the tire-pressure sensor receive the code identification signal and select one of the encoding systems according to the code identification signal; and

f) establishing signal communication between the tire-pressure sensor and the host.

The present invention enables the tire-pressure sensor to automatically adopt an encoding system suitable for the host of the pressure sensing system, so that the detection signal issued by the tire-pressure sensor is readable to the host, thereby allowing the host to obtain data of tire pressure detected by the tire-pressure sensor.

The present invention further includes a locking process, wherein the tire-pressure sensor is locked from entering the installing process again provided the tire-pressure sensor having selected the encoding system has never detected the tire pressure of the tire to be monitored as lower than the preset threshold throughout a signal locking period. This secures the tire-pressure sensor from being interfered with by other hosts and sending the measured tire pressure to a wrong host, thereby ensuring the communication between the host and the tire-pressure sensor and correct display of the tire pressure readings.

The present invention further includes a recovery process, wherein a restorer sending a recovery signal to the tire-pressure sensor that had selected the encoding system and has been locked from entering the installing process, so to restart and enter the tire-pressure sensor to the installing process, allowing the tire-pressure sensor to be installed on to another vehicle and work with that another host.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic drawing illustrating a smart tire-pressure sensing system of the present invention;

FIG. 2 is a schematic drawing depicting signal communication between a tire-pressure sensor and a host according to the present invention;

FIG. 3 is a flowchart of an automatic matching method of the present invention; and

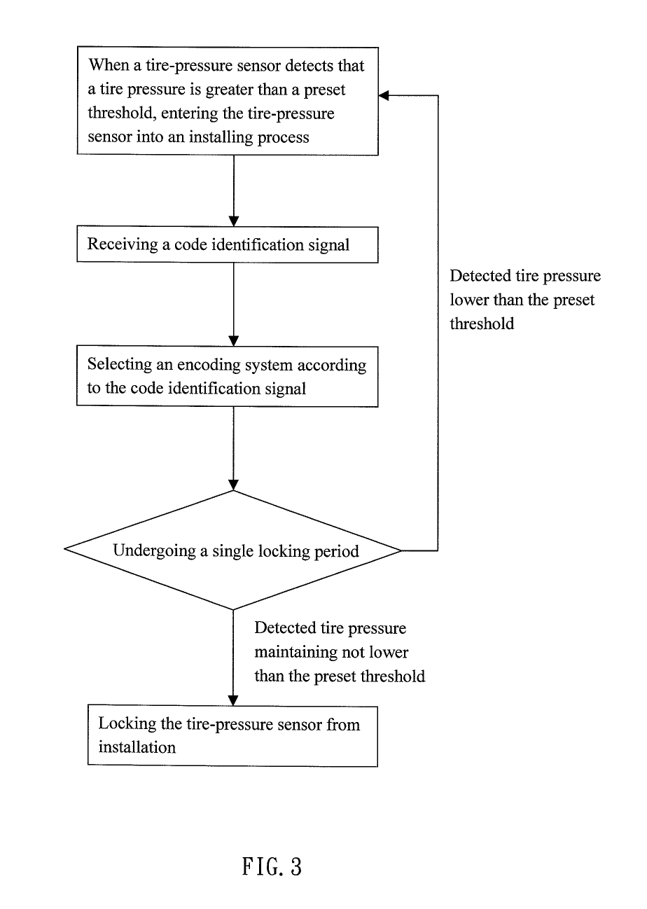

FIG. 4 is a schematic drawing explaining a recovery process according to the present invention.

### DETAILED DESCRIPTION OF THE INVENTION

While a preferred embodiment provided hereinafter for illustrating the concept of the present invention as described above, it is to be understood that the components of the embodiment shown in the accompanying drawings are depicted for the sake of easy explanation and need not to be made to exact scale.

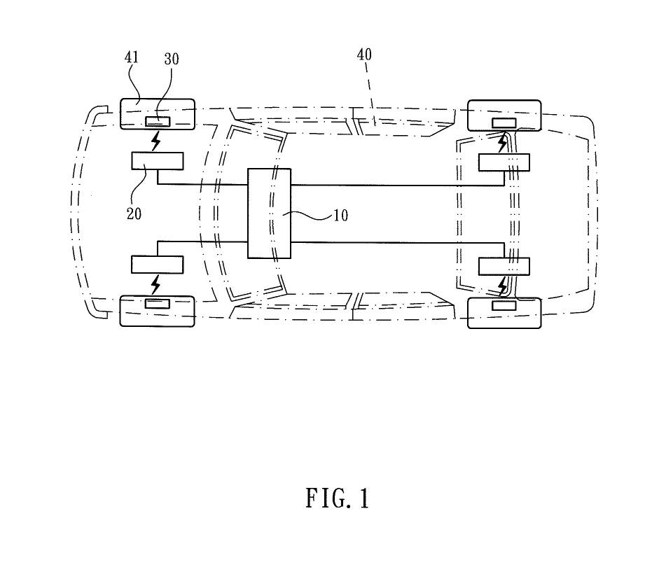

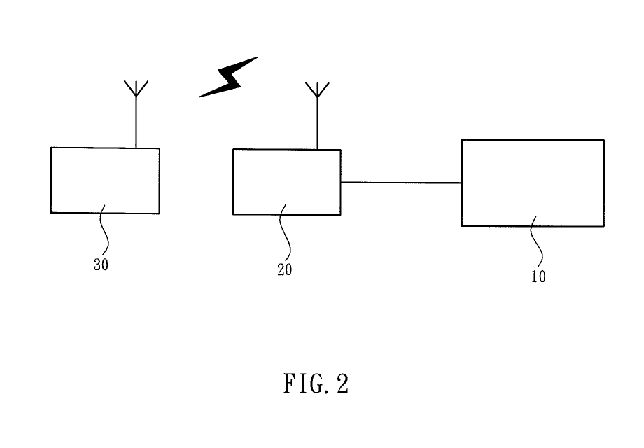

Referring to FIG. 1 and FIG. 2, a smart tire-pressure sensing system according to the present invention primarily comprises a host 10, at least one wireless transmitter 20, and at least one tire-pressure sensor 30.

The host 10 is installed on a vehicle 40, and each said wireless transmitter 20 is installed on the vehicle 40 at a proper position near a tire 41 whose tire pressure is to be monitored. The wireless transmitter 20 and the host 10 are connected in a wired manner.

Each said tire-pressure sensor 30 is installed in the tire 41 to be monitored. The tire-pressure sensor 30 and the host 10 are in wireless signal communication, so the measured tire pressure of the tire 41 can be transmitted to the host 10.

Therein, the tire-pressure sensor 30 is preloaded with a program compatible to multiple encoding systems. The program is configured to select one of the encoding systems to be in signal communication with the host 10 according to a code identification signal.

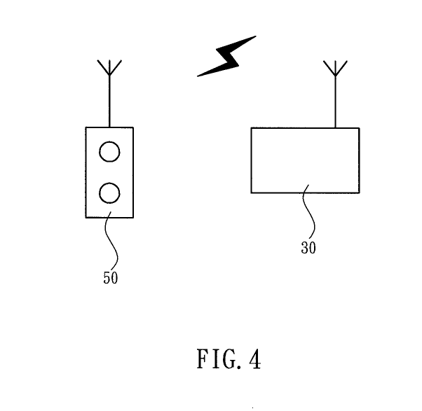

As shown in FIG. 4, the present invention also provides an automatic matching method for the smart tire-pressure sensing system. The automatic matching method comprises the following steps:

a) installing a tire-pressure sensor 30 compatible to the plural encoding systems into the tire 41 to be monitored;

b) inflating the tire 41 to make a tire pressure thereof greater than a preset threshold, wherein the preset threshold may be zero pressure or a pressure value much lower than a proper pressure;

c) automatically entering an installing process when the tire-pressure sensor 30 detects that the tire pressure is greater than the preset threshold, wherein when entering the installing process, the tire-pressure sensor 30 starts to detect and receive a code identification signal;

d) transmitting a code identification signal to the tire-pressure sensor 30;

e) making the tire-pressure sensor 30 receive the code identification signal and automatically select one of the encoding systems according to the code identification signal;

f) establishing signal communication between the tire-pressure sensor 30 and the host 10; and

h) after the tire-pressure sensor 30 selects a certain encoding system, if the tire-pressure sensor 30 does not detect the tire pressure of the tire 41 to be monitored 41 as lower than the preset threshold throughout a signal locking period, locking the tire-pressure sensor 30 from entering the installing process again.

Therein, the code identification signal of the step d) is a signal transmitted to the tire-pressure sensor 30 by the host 10 through a wireless transmitter 20. Alternatively, a code identifying tool may be implemented to send the code identification signal to the tire-pressure sensor, wherein the code identifying tool is configured to directly generate the code identification signal corresponding to the host 10, so as to allow the tire-pressure sensor 30 and the host 10 to automatically match and have signal communication therebetween.

By installing the tire-pressure sensor 30 of the present invention and then inflating the tire 41 to be monitored, the system can automatically adjust the encoding system adopted by the tire-pressure sensor 30 according to the code identification signal of the host 10, so as to allow a detection signal issued by the tire-pressure sensor 30 to match the host 10, thereby allowing the host 10 to successfully obtain the tire pressure of each said tire 41 to be monitored. The present invention adopts an automatic matching approach to facilitate establishment of signal communication between the host 10 and the tire-pressure sensor 30, so as not need to open the tire 41 to be monitored for setting, thereby simplifying the operation and saving work time.

Therein, for preventing signal interference from other systems in the course of the installing process, the tire-pressure sensor 30 is such configured that, after selecting a certain encoding system and establishing signal communication with the host 10, if the tire-pressure sensor 30 does not detect any change over a short period of time (e.g. within one hour), the tire-pressure sensor 30 automatically get prohibited from responding to signals from other hosts.

In addition, the locking process may further include that, after the tire-pressure sensor 30 selects a certain encoding system, if the tire-pressure sensor 30 has never detected the tire pressure of the tire 41 to be monitored as lower than the preset threshold throughout a signal locking period (e.g. within 13 hours), it is locked from entering the installing process again, so as to prevent the tire-pressure sensor 30 from reentering the installing process due to tire leakage or other reasons that cause the tire pressure to be lower than the preset threshold, and thereby prevent the tire-pressure sensor 30 from disconnecting from the host 10 or unintentionally matching and connecting other hosts (such as a host in a nearby vehicle). Thereby, the tire-pressure sensor 30 is secured from being interfered with by other hosts and transmitting the tire pressure measured by the tire-pressure sensor 30 to a wrong host, so as to ensure the connection between the host 10 and the tire-pressure sensor 30 installed in the same vehicle and correct reading of tire pressure presented at the host 10.

Before the tire-pressure sensor 30 finished the locking process, in the event that the tire has to be replaced for any reason, by discharging the tire pressure of the tire 41 to an extent lower than the preset threshold, the tire-pressure sensor 30 can return to its initial status and can enter the installing process when the tire 41 is re-inflated.

In addition, as shown in FIG. 4, the present invention further comprises a recovery process. In the recovery process, the tire-pressure sensor 30 that had selected the encoding system and has been locked from entering the installing process receives a recovery signal from a restorer 50, so that the tire-pressure sensor 30 is re-started and entered into the installing process, thereby allowing the tire-pressure sensor 30 and the tire 41 that are to be installed onto to another car to have signal communication with another host 10, making the tire-pressure sensor 30 reusable.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. An automatic matching method for a smart tire-pressure sensing system, the smart tire-pressure sensing system comprising at least one host and at least one tire-pressure sensor, the tire-pressure sensor being configured to be installed onto a tire to be monitored, preloaded with a program compatible to a plurality of encoding systems, and thereby capable of selecting one of the encoding systems according to a code identification signal so as to allow the tire-pressure sensor to have signal communication with the host and thereby transmit a measured value of a tire pressure of the tire to the host, and the automatic matching method comprising steps of:
a) installing the tire-pressure sensor into the tire to be monitored;
b) inflating the tire to make the tire pressure thereof greater than a preset threshold;
c) when the tire-pressure sensor detects that the tire pressure is greater than the preset threshold, entering the tire-pressure sensor into an installing process;
d) transmitting a code identification signal to the tire-pressure sensor;
e) making the tire-pressure sensor receive the code identification signal and select one of the encoding systems according to the code identification signal; and
f) establishing the signal communication between the tire-pressure sensor and the host.

2. The automatic matching method of claim 1, wherein in the step d) the code identification signal is sent to the tire-pressure sensor by the host.

3. The automatic matching method of claim 2, wherein the host transmits the code identification signal to the tire-pressure sensor through a wireless transmitter.

4. The automatic matching method of claim 3, wherein the host and the wireless transmitter are connected in a wired manner.

5. The automatic matching method of claim 1, wherein in the step d) the code identification signal is sent to the tire-pressure sensor by a code identifying tool.

6. The automatic matching method of claim 1, wherein the tire-pressure sensor entering the installing process detects and receives the code identification signal.

7. The automatic matching method of claim 1, wherein the signal communication between the tire-pressure sensor and the host is wireless signal communication, so that the tire-pressure sensor I capable of transmitting data of the tire pressure of the tire to be monitored to the host.

8. The automatic matching method of claim 1, further comprising a locking process:
wherein the tire-pressure sensor is locked from entering the installing process again provided the tire-pressure sensor having selected the encoding system has never detected the tire pressure of the tire to be monitored as lower than the preset threshold throughout a signal locking period.

9. The automatic matching method of claim 6, further comprising a recovery process:
wherein a restorer sending a recovery signal to the tire-pressure sensor that had selected the encoding system and has been locked from entering the installing process, so to restart and enter the tire-pressure sensor into the installing process.

10. A smart tire-pressure sensing system, comprising at least one host and at least one tire-pressure sensor, the tire-pressure sensor being installed in a tire to be monitored and being in signal communication with the host, so as to transmit a measured value of a tire pressure of the tire to the host, wherein the tire-pressure sensor is preloaded with a program compatible to a plurality of encoding systems and thereby capable of selecting according to a code identification signal one of the encoding systems so as to allow the tire-pressure sensor to be in the signal communication with the host.
